(19) United States
(12) Patent Application Publication
(10) Pub. No.: US 2014/0365403 A1
(43) Pub. Date: Dec. 11, 2014

(54) GUIDED EVENT PREDICTION

(71) Applicant: International Business Machines Corporation, Armonk, NY (US)

(72) Inventors: Steven Joseph Demuth, Decorah, IA (US); Matthew J. Duftler, Yorktown Heights, NY (US); Rania Yousef Khalaf, Cambridge, MA (US); Geetika Tewari Lakshmanan, Winchester, MA (US); Szabolcs Rozsnyai, Manhattan, NY (US); Merve Unuvar, Piscataway, NJ (US)

(21) Appl. No.: 13/912,275

(22) Filed: Jun. 7, 2013

(51) Int. Cl. G06N 5/04; G06N 99/00

(52) U.S. Cl. CPC G06N 5/048; G06N 99/005
USPC 706/11

(57) ABSTRACT

A method (and structure) for implementing a software tool, as executable by a processor on a computer to exercise any of a plurality of prediction tools. Questions are provided to a user output port, and inputs from a user input port are received as responses to the questions. The question responses are used to instantiate, customize, and configure a specific one of said plurality of prediction tools for executing a specific application on the software tool.

### BACKGROUND OF THE INVENTION

1. Field of the Invention

The present invention generally relates to software-implemented tools directed to prediction using any of a plurality of algorithms. More specifically, a mechanism is provided for user inputs which permit the tool to automatically determine the appropriate algorithm and to appropriately customize both the training data and the data whose outcome is being predicted.

2. Description of the Related Art

In existing literature, predictive algorithms have been mostly used in weather forecasting, quality prediction, or health or financial credit/score predictions.

For example, in U.S. Pat. No. 5,976,082 is described a method for identifying at risk patients diagnosed with congestive heart failure. A computer-implemented technique, including database processing, is used to identify at risk congestive heart failure patients where information about patients exists in a claims database. The technique includes processing the patient information in the claims database to find and extract claims information for a group of congestive heart failure patients. A prediction model is applied to the same or another claims database to identify and output at risk patients, diagnosed with congestive heart failure, likely to have adverse health outcomes.

Another example of a prediction tool is a software package entitled “SPSS Statistics”, now officially named “IBM SPSS Statistics” following acquisition in 2010 by IBM, is primarily used for statistical analysis. Originally, the acronym SPSS referred to “Statistical Package for the Social Sciences” since its first version in 1968 was intended as primarily directed to statistical analysis in the social sciences. The meaning was later modified as more broadly referring to “Statistical Product and Service Solutions”, since it became commonly used by market researchers, health researchers, survey companies, government, education researchers, marketing organizations, and others.

The present inventors have recognized a new problem in the art of prediction tools that permit users to perform different types of predictions such as logistic regression, decision trees, or other machine learning methods, such as exemplified by the SPSS Statistics prediction tool. Specifically, the present inventors have recognized that such existing prediction tools have no mechanism to obtain user guidance and incorporate that user guidance automatically in the selection and training of predictive models for the prediction processing to be executed by such tools.

### SUMMARY OF THE INVENTION

In view of the foregoing, and other, exemplary problems, drawbacks, and disadvantages of the conventional systems and prediction tools, it is an exemplary feature of the present invention to provide a structure (and method) in which to address a problem for such prediction tools directed to the prediction of tasks where the user has some knowledge about the predictors. In particular, the present invention introduces to such prediction tools a mechanism to make predictions under some guidance, as provided by the user's responses to various preliminary questions, thereby assisting the use in using the most appropriate prediction tool from among a number of available prediction tools. In an exemplary embodiment, the appropriate prediction tool is automatically selected for the user's intended application, based on the user responses that indicate the relative significance to the prediction for data and business process execution semantics.

It is another exemplary feature of the invention to provide a mechanism whereby the user can additionally discriminate some of the information from the others, in the prediction sense, for executing different prediction tools.

In a first exemplary aspect of the present invention, to achieve the above features and objects, described herein is a method including, for a software tool being executed by a processor on a computer, the software tool configured to exercise any of a plurality of prediction tools, initially providing a plurality of questions to a user output port. Inputs in response to these questions are received via a user input port. These question responses are used to at least one of instantiate, customize, and configure a specific one of said plurality of prediction tools for executing a specific application on the software tool that is related to the received responses.

In a second exemplary aspect, also described herein is a method including, for a software-implemented prediction tool configured to predict a user-specified target attribute for a partially-executed event sequence on a basis of a prediction model learned from a set of training data, the set of training data comprising historical data for completed event sequences, providing one or more questions to a user that indicate a relative significance of data and business process semantics and path information. Responses to these questions are used for determining which specific technique to use for making the user-specified target attribute prediction.

In a third exemplary aspect, also described herein is a method including, for a software-implemented prediction tool configured to predict a user-specified target attribute for a partially-executed event sequence on a basis of a prediction model learned from a set of training data, the set of training data comprising historical data for completed event sequences, receiving inputs from a user of the prediction tool that indicate which attributes to one of add and delete from data of the set of training data for the prediction model. Input data to be used for determining a prediction probability value of the user-specified target attribute is automatically edited to add or delete attributes and their associated values, based on these inputs for adding or deleting of attributes of the training data.

A benefit of the present invention is that user guidance is obtained and embedded in the selection and creation of prediction models automatically for business processes. Thus, instead of the user manually having to decide which prediction model to use, and figure out how to create attributes for training, the present invention prompts users for questions to facilitate this. This invention is useful in predictive software applications where users currently have to manually select and decide how to create prediction models and to manually configure training data.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows exemplarily an overview method 100 of a guided event prediction system in accordance with the present invention;

FIG. 2 shows in flowchart format 200 the sequence when data does not matter and business process semantics do not matter;

FIG. 3 shows in flowchart format 300 the sequence when data or business process semantics are important;

FIG. 4 shows in flowchart format 400 an exemplary sequence for automatic determination (selection) of a model or algorithm to use, as based in such user inputs as described herein;

FIG. 5 illustrates an exemplary hardware/information handling system 500 for incorporating the present invention therein;

FIG. 6 illustrates a signal bearing medium 600 (e.g., storage medium) for storing steps of a program of a method according to the present invention; and

FIG. 7 illustrates an exemplary graph 700 of a business process model.

### DETAILED DESCRIPTION OF EXEMPLARY EMBODIMENTS OF THE PRESENT INVENTION

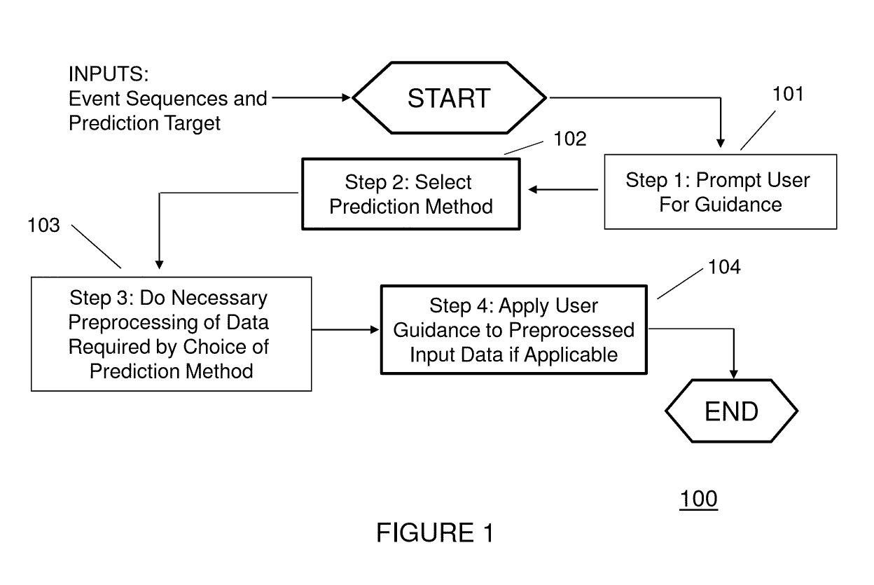

Referring now to the drawings, and more particularly to FIGS. 1-7, exemplary embodiments of the method and structures according to the present invention are demonstrated and explained.

As briefly described above, there are existing software tools, such as SPSS, SAS, and Rapid-I, that allow users to perform different type of predictions such as logistic regression, decision trees, or other machine learning methods. These tools, as well as others, are well known in the art of data mining and predictive analysis. Even though these software programs cover almost all types of prediction, the present inventors have recognized that they do not have question-driven systematic steps to obtain user inputs for guidance in the selection of choice of a specific prediction tool for each specific application or for specific mechanisms to apply the user guidance.

In a semi-structured business process, also referred to herein as a “case”, which is often evaluated using prediction tools such as SPSS, the order of activities (i.e., tasks) to be performed depends on many factors such as human judgment, document contents, and business rules. Users of a prediction tool such as SPSS, also referred to herein as “case workers”, decide which set of steps to take based on a large amount of data and case information.

Given the state of a case which consists of the activities executed and the data consumed or produced in the past, learning and predicting which activities will be performed in the future and how the case is going to end up is important for providing early alerts and guidance. This can also be used for business process simulation, and identifying best business practices.

Such decision support analysis requires analyzing the execution semantics of the business process. This can be done by analyzing traces of a business process's execution. A business process execution trace typically includes tasks and data associated with those tasks.

For example, consider a business process with five tasks, A, B, C, D, and E. A sample trace of the task execution sequence of an instance of this process could be: ABCCCCDE, or ABCDE, or ABCDCDCDE. Each task may have data attributes associated with it which will be logged in the trace along with the execution sequence of the tasks.

A key aspect of the present invention, as a difference between existing software and the present invention, is that the existing software merely creates the specific predictive models that the user requests, as a simple user input command. Existing tools do not allow users to explicitly provide guidance that will impact the choice of prediction tools, and also the inputs to the prediction tool. Typically when a user of an existing software application such as SAS or SPSS tries to create a predictive model, they have to select the model they wish to train, and are required to specify the attributes for training the model, as well as model parameters (such as confidence threshold etc).

In contrast, the present invention provides a mechanism for users to provide guidance in the format of providing responses to specific preliminary questions, and the guidance allows the tools to determine automatically (1) which models to learn, (2) how to configure the attributes for training the models. As exemplarily shown in FIG. 1, this result is achieved by prompts to the user 101, in order to determine:
1. Whether tasks matter in prediction;
2. Whether data and business process model semantics matter (such as loops and parallelism); and
3. Based on the answers to 1 and 2, the invention guides the user in terms of:
   a) Which algorithms to use for prediction 102;
   b) Customizing the training data that is fed as input to the predictive algorithms to learn predictive models by removing unnecessary training attributes, and adding additional training attributes; adding or removing training data attributes can be done manually by the user; adding or removing training data is also done automatically by the methods described in, and the decision of which method to invoke based on user guidance in order to automatically customize the training data is a contribution of this invention; and
   c) Customizing the learned predictive models by removing or adding predictive attributes 103, 104.

The present invention can also be viewed as enabling a method to make predictions when the importance of some of the data attributes is known and provided by the user as guidance. For instance, if it is known that the sequences of tasks have importance over the data attributes, which is one aspect of the guidance, then the mechanism can use this information to make predictions by modeling task sequences as attributes in training samples for learning predictive models. If it is known that data attributes have importance and, particularly, if some data attributes are directly impacting predictions, the mechanism can build a predictive model such that can be forced to include these attributes into the model.

Similarly, if it is known that some of the data attributes are not relevant in a prediction, these can be removed from the training sample set so that predictions can be made with the rest of the data attributes in the training sample set. Thus, the present invention provides a methodology for obtaining guidance from the user, and a system that leverages the guidance to make “guided” predictions to the user.

Relative to the conventional prediction tools, the method of the invention can also be viewed as providing different prompts to the user for guidance at different steps of making a prediction, so as to use the guidance to execute a sequence of stages, as follows:

1. Model Selection Phase: Which techniques to use for solving a prediction problem;

2. Model Training Phase: How to edit the training samples for a machine learning algorithm, and in particular deciding which attributes in each training sample to remove from training and which attributes to add.
a. If data and tasks matter, certain attributes should be designed and added to training samples for learning the model; and
b. If the user knows that certain attributes are irrelevant to the prediction model, these attributes and their associated values can be removed from the training samples from which the model is learned; and

3. Using Learned Model phase: How to edit the model learned by techniques in (1) and/or (2) and in particular deciding on which parameters (attributes that influence the prediction model's answers) to forcibly add to the model and which ones to forcibly remove from the model.

The first phase of selecting a model can be further broken down into three stages. A first stage of this determination is based upon whether parallel paths are involved. In the second stage, it is determined whether the process involves loops (“cycles”), and the third stage is based upon whether or not a Markov process is involved.

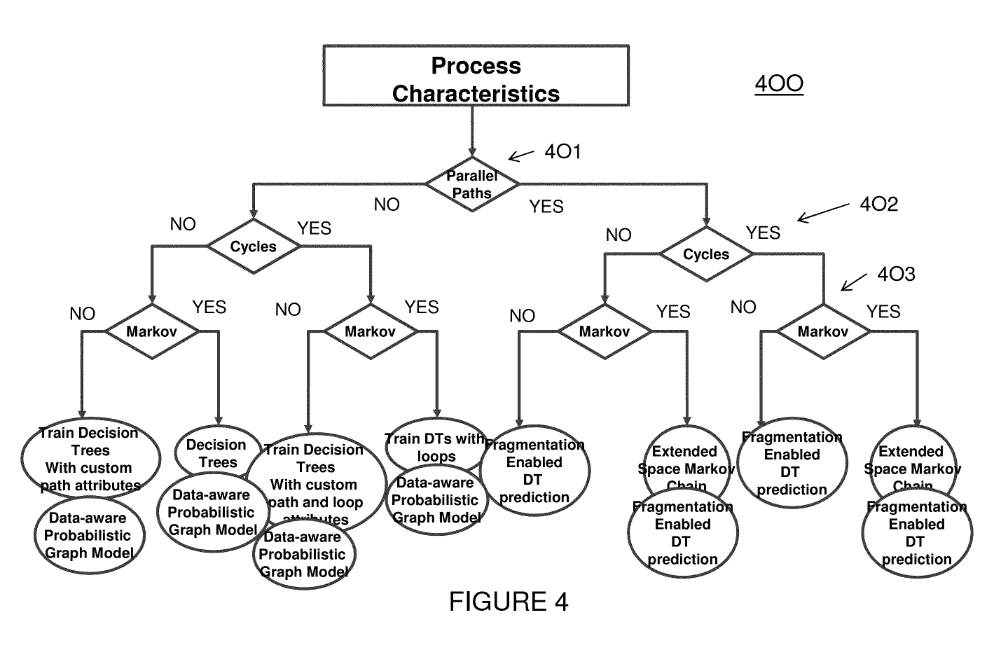

It is noted that, in the context of the present invention, a “Markov process” is one in which a next stage in the process is not based upon history of previous stage(s). That is, in a Markov process, there is a random probability that is known for the process, such that, given a current state of the process, the next state will proceed with random probability to any other state of that process. It is noted that FIG. 4 shows these three stages more graphically, as a flowchart 400 that demonstrates how the method determines specific models under different user inputs.

In a general exemplary embodiment of a tool incorporating concepts of the present invention, the initial inputs into the tool are historical event sequences or completed process execution traces, a given event sequence of events (or a current trace) with most recent data, and a prediction target (e.g., what is desired to be predicted). In accordance with the present invention, the user provides guidance as an input, and the output of the tool will be the prediction probability of the likelihood of the target.

The user wants to predict the likelihood of an event before that event occurs. In some cases, the user might have some insight on predictive attributes that influence the outcome such as the importance of the event sequence path, business process semantics, and/or data. The goal is to make predictions while taking this guidance into account. User guidance will be incorporated in different stages of the prediction process. FIG. 1 summarizes in flowchart format 100 all the high level steps to accomplish this goal.

As mentioned, present invention can be viewed as taking into account two guidance categories:

(1) data; and

(2) semantics and path information.

In this context, the first category “data” refers to whether data influences outcomes in the process. That is, it is possible that only the execution of tasks influences outcomes in a business, and not data. It is also possible that in a business process nothing influences outcomes. If data influences outcomes in a business process, it is important to include data attributes in the training of the prediction model that will be used to predict outcomes in the process. Data attributes could be, for example in an insurance claims process, data could refer to the damage area of the car, the number of previous accident's by a driver, the driver's age, the cost of the car, etc.

Relative to the second category identified above, “business process semantics” refers to parallelism and loop behavior that occurs in a business process. For example, in an insurance process, a case worker may do two or more tasks in parallel, such as create a claim and then do a background check. A loop refers to one or more activities that repeat themselves. For example, while handling an insurance claim, a case worker may call a customer multiple (e.g., ten) times until sufficient information has been documented. In this case the “call customer” task would loop ten times.

The “path information” of the second category refers to the sequence of historically executed tasks in a business process or in a case or in a computer system. Such sequence of historically executed tasks may influence future outcomes in a business process. For example, if a patient is given Diuretics followed by AntiAnginalAgents, where “Give Diuretics, and “give AntiAnginalAgents” are two tasks in a business process, the order of execution of these tasks may influence the likelihood of the patient being diagnosed with fluid loss. Similarly, if a patient is given AntiAnginalAgents followed by Diuretics, where “Give Diuretics, and “give AntiAnginalAgents” are two tasks in a business process, then the order of execution of these two tasks may increase the likelihood of this patient having high blood pressure.

The user, accordingly, can provide information on whether data and/or semantics are important or not in the course of prediction. Moreover, the user can prioritize some of the data attributes starting from very important to less important. S/he can tell the model to include some certain data attributes and exclude some insignificant ones.

The following description provides additional details on all possible guidance that the user can provide in an exemplary embodiment.

Case 1: Data and/or Business Process Semantics and Path do not Matter

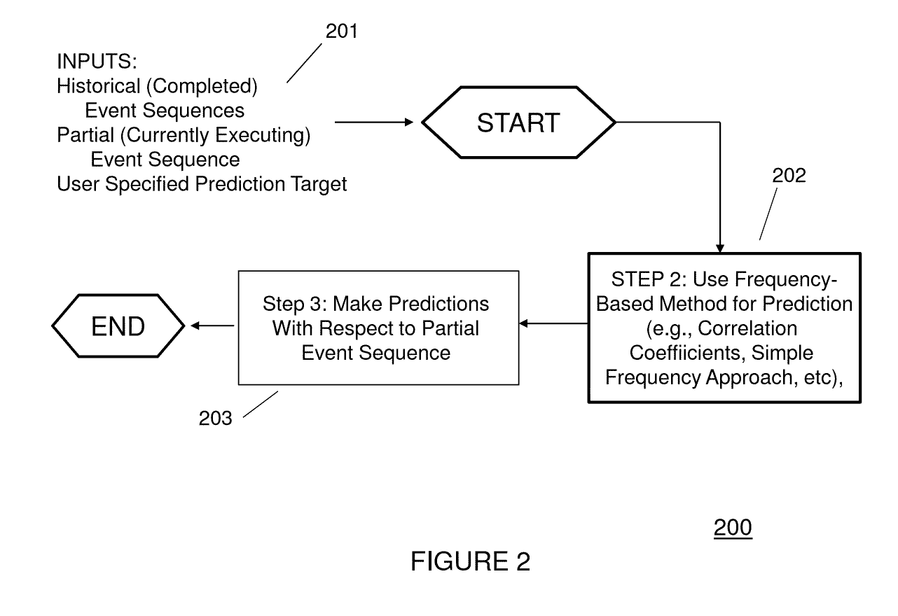

FIG. 2 shows in flowchart format 200 the sequence in which data does not matter and/or business process semantics and path do not matter. That is, it is supposed that data and/or path information do not matter in the prediction, and this information is provided by the user as guidance inputs 201. Under this guidance, the tool will first regroup the set of traces such that same traces with a target trace will be in the same group (not shown in FIG. 2). The method will be using this group, which is a subset of the whole training set, as the training sample. Later, some frequency based methods, such as correlation coefficient or simple frequency approach, will be used to calculate the predicted outcome 202, 203. The steps for prediction under guidance of this type are given in the exemplary flowchart 200 of FIG. 2.

A decision tree can also be used in this case to classify the outcome. Since there are no data attributes, the tree will predict the outcome based on the frequency of historical executions.

### Example

### Let Us have Following Event Sequences to Demonstrate this Method

ABCD

ABCE

ABCD

ABCD

ABCD

ABFD

ABFE

ABCD

ABCE

ABCE

ABFE

If one would like to predict the next task after the pattern ABC is observed, then we should take the subset of the overall traces that contain ABC. After collecting the data that contains ABCx patterns only, many methods could be used to address the same questions. Here we describe two potential approaches: the frequency based approach and the correlation coefficient based approach.

### The Frequency Based Approach:

The first approach considers that, if data does not matter, we can simply take the frequency of different outputs and report the biggest one as a most probable output. Even if we use decision trees or some other machine learning method, since it will classify the data based on different output frequencies, it will not make anything different from that of looking at the frequency distribution of the training sample.

In the given example, there are eight ABCx and three of them ended in E and five of them ended in D. Therefore, based on this sample, our prediction would indicate that 37% of the time, the ABC pattern will perform task E, and 63% of the time, the ABC pattern will perform task D.

### The Correlation Coefficient Based Approach:

The second approach basically looks at the correlation between the pattern and the possible outcomes. It reports the highest correlation as a potential prediction.

For instance, in the same example above, let us name the correlation coefficient between “ABC” and “E” as c1. Let us name the correlation coefficient between “ABC” and “D” as c2. The higher the coefficient value, the better the prediction is. Therefore, max(c1,c2) will be the result of the correlation coefficient based approach.

Note that in Step 2 of FIG. 2, machine learning algorithms such as decision trees can also be used to compute predictions when data does not matter. In such situations, decision trees use the frequency of historical executions to determine the likelihood of an outcome in a given instance.

Case 2: Data Matters and/or Business Process Semantics and Path Matter

In contrast to the scenario of FIG. 2, it is now supposed that data matters. In other words, what is meant is that data attributes contain useful information regarding to prediction and it is desirable to use this information while making predictions. In this scenario, not only do we take into account the data attributes, we also use the guidance that the user provides on the importance of the data attributes to guide the prediction.

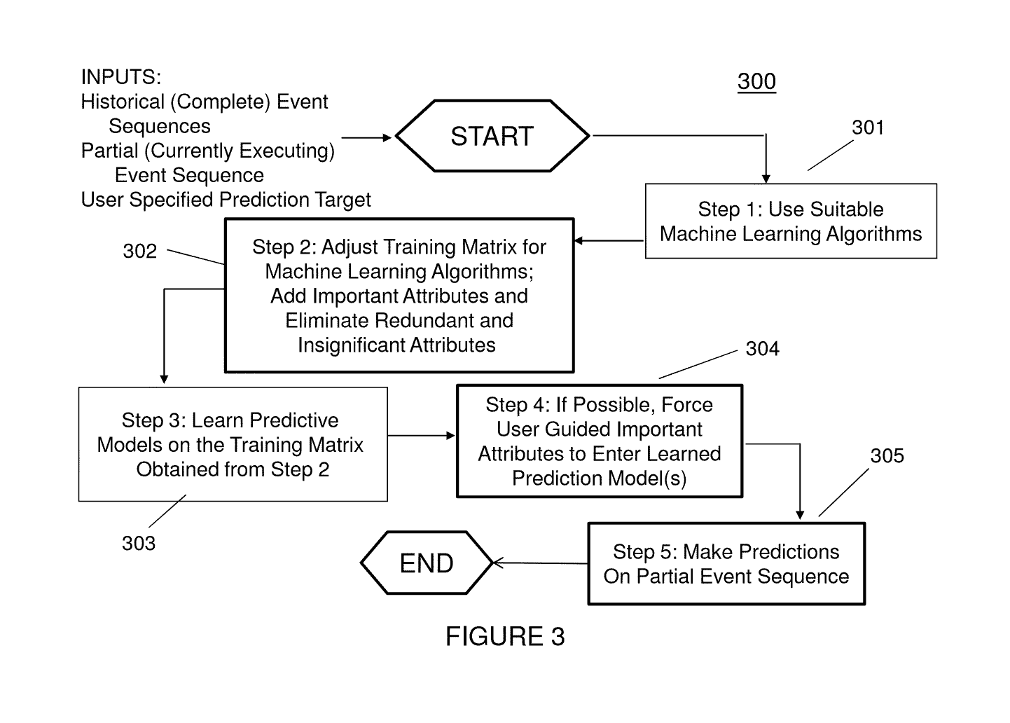

First, the method of the present invention assists the user to select suitable machine learning algorithm based on the guidance that the user provides (e.g., 301 in FIG. 3).

Next, the method manipulates the training sample in order to exclude insignificant data attributes or adds additional attributes that capture business process semantic information (e.g., 302 in FIG. 3). In 303, the predictive model is developed.

Then, if we have guidance towards the ranking of importance of the data attributes, then we force our model to include certain attributes or exclude certain attributes (e.g., FIG. 3, 304).

### Background on Training a Decision Tree

Using a set of historical execution traces of a process, one can train a decision tree at a point in an event stream or alternatively at a decision point in a business process. As training samples we can use a set of completed process execution traces of this process (for which it is already known which alternative path they have followed with respect to the decision point) or historical event stream data. The data attributes to be analyzed are the data attributes contained in the completed execution traces (of the event stream or of a business process's instances).

Suppose, for example, that the data attributes considered are account type, customer age, transaction amount, match credit card number and vendor credit score. Each row of Table A corresponds to a training example for the decision tree extracted from a single instance of the process. The last column represents the (decision) class, which denotes the decision that has been made by the process instance with respect to the decision node as to whether activity C (i.e. Vendor Fraud Determination) or D (i.e. Customer Fraud Determination) is executed. This table is also referred to as a training matrix for the decision tree (e.g., a machine learning algorithm).

TABLE A
Training samples for a decision tree.

| | | | | Match | Vendor | |
|---|---|---|---|---|---|---|
| Caller | Account | Customer | Transaction | CC | Credit | Deci- |
| ID | Type | Age | Amount | Number | Score | sion |
| 895 | other | 68 | $6,665 | yes | bad | C |
| 896 | student | 32 | $9,844 | no | good | D |
| 901 | other | 77 | $6,006 | yes | good | C |
| 902 | student | 21 | $6,356 | no | bad | D |

C refers to Vendor Fraud Determination and D refers to Customer Fraud Determination

A good example to illustrate this case comes from an insurance industry. Auto-insurance is a good candidate for explaining the present invention because an auto-insurance process is typically semi-structured, document driven.

An auto-insurance process starts with a claim. After an insurance claim is opened, the case worker collects documents such as an accident report, personal information about the customer, etc. Depending on the document content and personal judgment, the case worker needs to make a decision on which tasks to conduct next. Among the data that case worker collects, some of the data attributes could be more important than others.

For instance, most of the times, the accident report is the most predictive data attribute. Therefore, one would want to include this information in making predictions. However, among the personal information of the driver, height, and weight information of the driver usually do not have any predictive power. Therefore, one would typically not want to include theses attributes in the models.

The predictive importance of these data attributes are usually given by the user based on their area of expertise as guidance to modeler. Basically, a user might provide guidance as below:

1. All data attributes have equal importance;

2. Some of the data attributes have more importance;

3. Some of the data attributes have no importance;

4. Business process semantics have importance along with the data; and

5. Business process semantics have importance without the data.

The following describes how a user could guide prediction using standard machine learning techniques that require a training set.

### Modifications to the Training Matrix Based on User Guidance

This first guidance corresponds to step 2 in FIG. 3.
1. If all Data Attributes have Equal Importance

If data matters in the prediction and all data attributes have equal importance, then it is necessary to include this information into the prediction algorithm. Moreover, it would be necessary to train a decision tree (or any machine learning algorithm) with the data that is available up to the decision point by assigning a target value. For example, in the previous training sequence example, the target values would be D or E. The decision tree will look into training sample, will identify the properties of the traces that ended in D or E, and make an accurate prediction when a test trace comes.

2. Some Data Attributes have More Importance Modifications to the Learned Predictive Model Based on User Guidance

This corresponds to step 4 in FIG. 3.

If the user knows in advance that some data attributes have more importance, then it is possible to use logistic regression, among other predictive tools, where those important variables can be forced to enter the model.

For instance, a typical regression equation looks like: ax_{—}1+bx_{—}2+cx_{—}3+e=y. If user guides the model with the information of the most predictive variable as x_{—}1 then we will force model to keep x_{—}1 in the equation.

It is noted that the software SAS tool already has an “INCLUDE” option, where the user can build models by forcing them to include a specific variable, so that feature can be readily incorporated into this exemplary baseline tool.

3. If it is Known in Advance that Some Data Attributes have No Importance

In this scenario, one can eliminate the insignificant data from the training sample and use any machine learning algorithm (i.e., decision trees, logistics regression, etc) to build models.

For instance, with the same example of tasks A, B, C, D and E, if the task C is not predictive, then we can eliminate the data associated with task C and create a new training matrix.

4. If it is Known in Advance that Semantics have Importance Along with the Data

In this scenario it is possible to use a fragmentation method, such as described in U.S. patent application Ser. No. 13/279,067, filed on Oct. 21, 2011, to Doganata, et al., include the path information and business model semantics into the prediction.

Thus, in an exemplary method of the present invention, one can decompose the business process model into fragments in which can be included the unique path information into the model and then combine the results of these fragments to make the prediction. More detailed explanation for how to decompose business process model into fragments, can be found in the '067 application.

Next, the semantics of cycles will be included during the training stage. Here, one can use training with loops/repeated tasks method, as further described in U.S. patent application Ser. No. 13/598,185, filed on Aug. 29, 2012, to Doganata, et al, to include the cycle information along with the path information into the prediction.

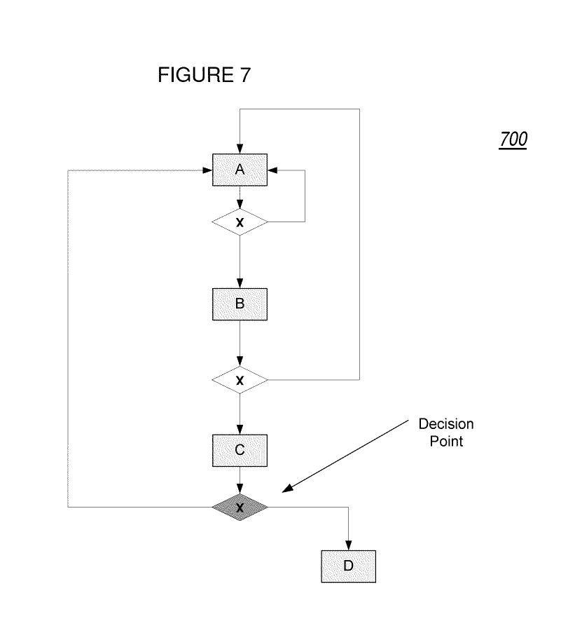

The example shown in FIG. 7 demonstrates this method using a business process model.

Assume that we would like to predict the likelihood of task D and have the following trace for training:

A B A B A B A A A A A A A A A A A B A B A B A B A B C A B C A A A A B A B A B C A B C A B C A A A B A B A A A B C D

We need to identify all the cycles that happen before the decision point. Since decision point is at C, we can subdivide the trace to sub-traces whenever C is visited. It is noted that there are two different cycle types, A and AB, in this particular example.

The cycling tasks in the execution trace path can also be expressed by indicating the number of cycles instead of repeating the task sequence at every cycle. Hence, the trace [ABABAB] can be expressed [AB]̂3. Every time a decision point is visited, a decision is produced. The sub-traces that produce a decision form training sequences.

Thus, from the graph 700 shown in FIG. 7 and for the example given above, the training sequences and the associated decision are given in the following table:

TABLE 1
Sub-trace instances at the decision point

| Sub-trace | Sub-trace expression | Outcome at C |
|---|---|---|
| ABABAB | [AB]\hat{ }3 [A]\hat{ }10 [AB]\hat{ }5 | A |
| AAAAAAAAAA | | |
| ABABABAB AB | | |
| AB | [AB] | A |
| AAA ABAB AB | [A]\hat{ }3 [AB]\hat{ }3 | A |
| AB | [AB] | A |
| AB | [AB] | A |
| AA ABAB AA AB | [A]\hat{ }2 [AB]\hat{ }2 [A]\hat{ }2 [AB] | D |

We do not need to include the task “C” to the sub-traces since it is obvious in our example that each sub-trace will end with C. Therefore, there would be no additional significant information to be gained for training purposes due to having C at the end of all sub-traces.

Since, in theory, an infinite number of cycles could occur, the number of sub-trace expressions could explode. Each sub-trace is a training sequence and adds a row to the instances table. As a result, the number of rows could also explode. One way of controlling the explosion of the sub-trace expressions is to separate the cycling frequencies from the expressions and add a column for every possible cycling set, such as done below in Table 2.

TABLE 2

| | [A] | [AB] | [A] | [AB] | | | | | | | | | | | OUTPUT |
|---|---|---|---|---|---|---|---|---|---|---|---|---|---|---|---|
| [AB][A][AB] | 0 | 3 | 10 | 5 | | DAB1 | DAB2 | DAB3 | DA1 | . . . | DA10 | DAB1 | . . . | DAB5 | |
| [AB] | 0 | 1 | 0 | 0 | | DAB1 | | | | | | | | | |
| [A][AB] | 1 | 1 | 0 | 0 | DA1 | | | | | | | | | | |
| [AB] | 0 | 1 | 0 | 0 | | | | | | | | | | | |
| [AB] | 0 | 1 | 0 | 0 | | | | | | | | | | | |
| [A][AB][A][AB] | 1 | 1 | 1 | 1 | DA1 | | | | DA1 | | | DAB1 | | | |

Every time a decision point is visited, the information about the execution path is kept by the sub-trace expression and the columns for the cycling times are updated. The data accumulated incrementally at the end of each task is additional information that may be impacting the result of the prediction. If such is the case, then information about the data at every task should also be collected and kept.

Keeping the incremental data at every task, however, may not scale well. In the example above, if the data at the end of each cycle needs to be kept, then, to represent the incremental data for the first row, we would need 3+10+5=18 columns, given that the cardinality of each data vector is 1. The total number of columns that is needed in order to represent the data behavior of the whole trace is the maximum number of columns required for each sub-trace.

In cases where only the data accumulated at the last cycling is important, the number of columns will be limited to the number of different cycles traversed before the decision. As an example, for the first row, we will have only DAB3, DA10 and DAB5.

5. If we Know in Advance that Semantics in Addition to Path has Importance without the Data:

In this scenario, one can include only the semantics of the business process model, such as the number of cycles, in addition to path information into the prediction.

For instance, if we consider the same business process model as above, with the same training sample, then we can create a training sample by counting the different number of loops and add it into our training sample.

| | Number of | Number of | Outcome |
|---|---|---|---|
| Sub-trace | AB Cycle | A Cycle | at C |
| ABABAB | 8 | 10 | A |
| AAAAAAAAAA | | | |
| ABABABAB AB | | | |
| AB | 1 | 0 | A |
| AAA ABAB AB | 3 | 1 | A |
| AB | 1 | 0 | A |
| AB | 1 | 0 | A |
| AA ABAB AA AB | 3 | 4 | D |

Then, one can use this training sample to train any machine learning algorithms (i.e. decision trees, logistics regression etc) to build predictive models.

Automatic Determination of Model/Algorithm

FIG. 4 shows in decision chart format 400 a sequence of user inputs that would permit a prediction tool to automatically determine, based on the guidance provided by a user, a preferred prediction algorithm or model to use. The guidance provided by the user is indicated in the splitting criteria (diamond shapes). This decision chart splits the choice of algorithms to use for prediction based on whether a business process contains parallelism 401, next whether the process contains loops (referred to as cycles) 402, and finally whether the Markov property holds 403. If a process holds the Markov property, it means that the process is memory less, i.e. the historical execution sequence of tasks does not matter. So, the user would provide guidance in terms of whether Parallel paths (step 401), cycles (step 402) and the Markov property (step 403) influence the outcomes in a business process, and our invention incorporates this guidance in the selection of the prediction model to use and subsequently training of that prediction model (as described in great detail earlier on in this embodiment).

For example, one possible path through this chart is Parallel Paths=Yes, Cycles=Yes, Markov=No. In this case, the algorithm specified by the decision chart are: Train Decision Trees with Loops using the technique specified in the '185 patent application previously mentioned, or one can also use Data-aware Probabilistic Graph Models which are described in U.S. patent application Ser. No. 12/910,573, filed on Oct. 22, 2010, to Duan, et al.

At this point it is noted that, although the exemplary embodiment described above suggests that the tool automatically determine and implement whichever prediction tool is most appropriate for the intended application, based on the user's responses to the preliminary questions, the present invention is not intended as being so limited, since it should be clear that alternatives are possible.

For example, a menu selection could be used to permit the user to enable or disable the preliminary questioning and automatic selection of the prediction tool, thereby permitting the user to disable the present invention. In another exemplary embodiment, the mechanism of the present invention could be used to make a recommendation to the user, with the user then providing an additional input to either confirm this recommendation or to use a prediction tool different from that recommended by the mechanism of the present invention. Similar alternative mechanisms could be implemented for the automatic conditioning of input data.

### Exemplary Hardware Implementation

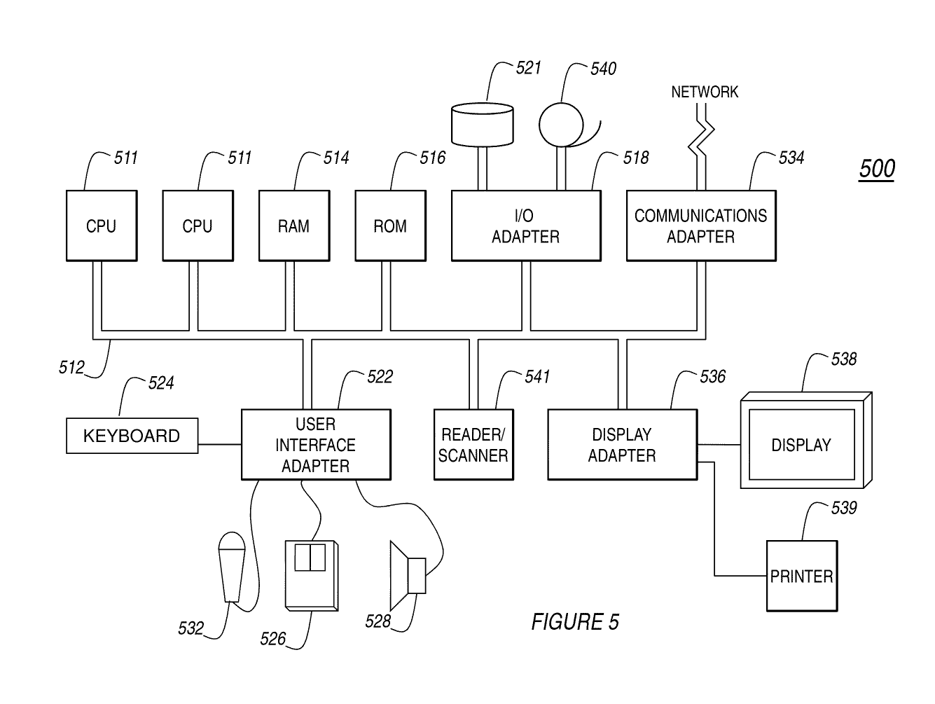

FIG. 5 illustrates a typical hardware configuration of an information handling/computer system in accordance with the invention and which preferably has at least one processor or central processing unit (CPU) 511.

The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, an Intranet, a personal area network (PAN), etc., and a display adapter 536 for connecting the bus 512 to a display device 538 and/or printer 539 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising non-transitory signal-bearing storage media tangibly embodying a program of machine-readable instructions executable by a digital data processor incorporating the CPU 511 and hardware above, to perform the method of the invention.

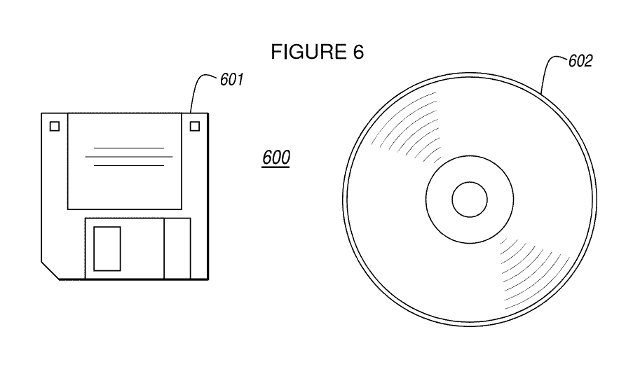

This storage media may include, for example, a RAM contained within the CPU 511, as represented by the fast-access storage for example. Alternatively, the instructions may be contained in another storage media, such as a magnetic data storage diskette 601 or optical diskette 602 (FIG. 6), directly or indirectly accessible by the CPU 511.

Whether contained in the diskette 600, the computer/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method for implementing a software tool, as executable by a processor on a computer, said software tool configured to exercise any of a plurality of prediction tools, said method comprising:
providing questions to a user output port;
receiving inputs from a user input port as responses to said questions; and
using said question responses for determining which specific one of said plurality of prediction tools to at least one of instantiate, customize, and configure for executing a specific application on said software tool.

2. The method of claim 1, wherein said question responses comprise information directed to determining a relative importance of data and a business process execution semantics and path information.

3. The method of claim 2, wherein said determining of relative importance of data/business process execution semantics and path information is indicative of whether:
all data attributes have equal importance;
some data attributes have more importance;
some data attributes have no importance;
business process semantics have importance along with the data; and
business process semantics have importance without the data.

4. The method of claim 2, wherein said question responses comprise information for customizing one or more attributes of training data for training a model implemented by said specific prediction tool.

5. The method of claim 1, wherein said plurality of prediction tools comprises machine learning tools based on one of logistic regression and decision trees.

6. The method of claim 5, wherein said plurality of prediction tools implements one of a data-aware probabilistic graph model and a fragmentation enabled decision tree prediction.

7. The method of claim 1, further comprising providing outputs to said user output port, for action by a user of said software tool.

8. The method of claim 1, wherein said software tool:
executes a prediction model learned from a set of training samples created from completed historical executions of events that represent a superset of partially-executed event sequences; and
uses said prediction model to make a prediction for a user-provided target attribute for a partially-executed event sequence.

9. The method of claim 8, wherein said questions are directed to:
whether data associated with each of a task instance or an entire event sequence matters; and
whether execution semantics matter in terms of repeated task executions and parallel tasks execution.

10. The method of claim 1, wherein said software tool, based on said responses received for said questions, one of:
automatically selects a most appropriate prediction tool from among said plurality of prediction tools; and
provides an indication to a user of which prediction tool has been determined as most appropriate.

11. A non-transitory, computer-readable storage medium embodying the method of claim 1, as a set of machine-readable instructions tangibly embodied in said storage medium.

12. The storage medium of claim 11, as comprising one of:
a read only memory (ROM) device on a computer, as a set of instructions selectively to be executed by said computer;
a random access memory (RAM) device on a computer, as a set of instructions currently being executed by said computer;
a standalone memory device that can be interfaced to a computer to load said set of instructions into a memory of said computer; and
a read only memory (ROM) device on a first computer, as a set of instructions selectively to be downloaded by said first computer onto a second computer interconnected with said first computer.

13. A method, comprising:
for a software-implemented prediction tool configured to predict a user-specified target attribute for a partially-executed event sequence on a basis of a prediction model learned from a set of training data, said set of training data comprising historical data for completed event sequences, providing one or more questions to a user that indicate a relative significance of data and business process execution semantics and path information; and
receiving responses to said questions and using said responses to make a selection of a technique to make said user-specified target attribute prediction.

14. The method of claim 13, further comprising providing one or more additional questions to the user, based on said selected technique, and using responses therefrom to determine which attributes to one of add and delete from data of said set of training data for a prediction model implementing said selected technique.

15. The method of claim 14, further comprising, for input data to be used for determining a prediction probability value of the user-specified target attribute, editing said input data to add or delete attributes and their associated values.

16. The method of claim 13, wherein said one or more questions are directed to determining:
whether said event sequences have a parallel path characteristic;
whether said event sequences have a looping cycle characteristic; and
whether said event sequences have a memory characteristic.

17. The method of claim 13, wherein said one or more questions comprises a question whether said historical data for completed event sequences includes data having a parallel path characteristic, wherein said technique to make said user-specified target attribute prediction comprises:
a fragmentation-enabled decision tree prediction model, if said response indicates that said data has said parallel path characteristic; and
a data-aware probabilistic graph model, if said response indicates that said data does not have said parallel path characteristic.

18. A non-transitory, computer-readable storage medium embodying the method of claim 13, as a set of machine-readable instructions tangibly embodied in said storage medium.

19. The storage medium of claim 17, as comprising one of:
a read only memory (ROM) device on a computer, as a set of instructions selectively to be executed by said computer;
a random access memory (RAM) device on a computer, as a set of instructions currently being executed by said computer;
a standalone memory device that can be interfaced to a computer to load said set of instructions into a memory of said computer; and
a read only memory (ROM) device on a first computer, as a set of instructions selectively to be downloaded by said first computer onto a second computer interconnected with said first computer.

20. A method, comprising:
for a software-implemented prediction tool configured to predict a user-specified target attribute for a partially-executed event sequence on a basis of a prediction model learned from a set of training data, said set of training data comprising historical data for completed event sequences, receiving inputs from a user of said prediction tool that indicate whether data and business process execution semantics and path matter and which attributes to one of add and delete from data of said set of training data for said prediction model; and
automatically, for input data to be used for determining a prediction probability value of the user-specified target attribute, editing said input data to add or delete attributes and their associated values, based on said inputs for adding or deleting of attributes of training data.
